(19) United States
(12) Patent Application Publication
(10) Pub. No.: US 2013/0068891 A1
(43) Pub. Date: Mar. 21, 2013

(54) Structural Panel for a Satellite, with Integrated Heat Exchangers

(71) Applicants: Julien HUGON, Montauroux (FR); Thierry DARGENT, BEAU-SUR-SAIGNE (FR)

(72) Inventors: Julien HUGON, Montauroux (FR); Thierry DARGENT, BEAU-SUR-SAIGNE (FR)

(73) Assignee: THALES, Neuilly-sur-Seine (FR)

(21) Appl. No.: 13/423,016

(22) Filed: Mar. 16, 2012

(30) Foreign Application Priority Data
Mar. 17, 2011 (FR) 11 00807

(51) Int. Cl. B64G 1/58

(52) U.S. Cl. 244/171.8

(57) ABSTRACT

A structural panel for a satellite comprises an outer skin intended to be outside the satellite, a core comprising at least one integrated heat pipe mounted in fixed contact with said outer skin, and an inner skin intended to be inside the satellite, said structural panel being equipped with generic heat exchangers which are adapted to be associated with a heat control circuit using the circulation of a liquid coolant, said circuit being situated outside the panel.

### CROSS-REFERENCE TO RELATED APPLICATION

This application claims priority to foreign French patent application No. FR 1100807, filed on Mar. 17, 2011, the disclosure of which is incorporated by reference in its entirety.

### FIELD OF THE INVENTION

The present invention relates to a structural panel for satellites, notably communications satellites.

### BACKGROUND

Satellites, notably communications satellites, have an expensive structure, notably because of the design of their heat control system which is conventionally formed by networks of heat pipes.

It is also expensive to construct satellite structures, notably because the control system of each satellite is unique.

An object of the invention is to reduce the cost of constructing a satellite, and to improve its heat control system.

### SUMMARY OF THE INVENTION

According to one aspect of the invention, a generic structural panel for a satellite is proposed which comprises at least one integrated heat pipe mounted in fixed contact with said outer skin, and an inner skin intended to be inside the satellite. The structural panel is equipped with generic heat exchangers which are adapted to be associated with a heat control circuit using the circulation of a liquid coolant, said circuit being situated outside the panel.

Also, such a panel is generic and makes it possible to reduce the cost of constructing satellites, and to facilitate the production of the heat control system of the satellite. This makes it possible to have greater modularity and reduced costs.

Said heat control circuit is, for example, a mechanically pumped two-phase heat circuit.

In one embodiment, said heat exchangers comprise at least one evaporator and one condenser.

It is thus possible to easily produce a heat control system comprising a mechanically pumped control circuit or loop, for example a two-phase mechanically pumped loop or MPL, or a heat pump system or HPS.

In one embodiment, said condenser is arranged in contact with the outer skin of the panel, facing at least one heat pipe of the core of the panel.

As an alternative, said condenser is arranged in contact with at least one heat pipe of the core of the panel.

Such configurations thus make it possible to limit the size of the condenser exchangers as the heat is distributed in the panel by the heat pipes. This compact design makes it possible to minimize the risks of the condensers being struck by micrometeorites.

Said evaporator is advantageously arranged in the core of the panel in contact with the inner skin of the panel.

It is thus made considerably easier to arrange dissipative equipment on the structural panel.

In one embodiment, the structural panel comprises at least one set of condensers connected in series and/or in parallel by a duct adapted to be part of said heat control circuit, outside the panel.

Each panel can thus be fitted easily into the heat control circuit.

Said condensers and said duct connecting them advantageously comprise hardened outer walls.

The compact condensers are thus protected from impacts, notably by micrometeorites.

The core of the structural panel can comprise a structure comprising a thermally insulating or thermally conductive material.

Thermal decoupling or coupling of exchangers, evaporators, and condensers integrated within one and the same structural panel can thus be envisaged depending on requirements and the type of MPL loop or HPS.

Furthermore, the structural panel equipped with heat exchangers is adapted to be connected hydraulically in series and/or in parallel with one or more other panels.

According to another aspect of the invention, a satellite is also proposed, characterized in that it comprises at least one structural panel as claimed in one of the preceding claims.

### BRIEF DESCRIPTION OF THE DRAWINGS

The invention will be better understood on examining some embodiments described by way of non-limiting examples and illustrated by the attached drawings, in which:

FIG. 1 illustrates schematically a view in cross-section along a first axis of a structural panel according to one aspect of the invention;

FIG. 2 illustrates schematically a view in cross-section along a second axis, orthogonal to the first axis, of a structural panel according to one aspect of the invention;

FIG. 3 illustrates schematically a front view of the inner skin of a structural panel according to one aspect of the invention;

FIG. 4 illustrates schematically a front view of the outer skin of a structural panel according to one aspect of the invention; and

FIGS. 5a and 5b illustrate a structural panel according to one aspect of the invention, as a component respectively of a heat control system of the MPL two-phase loop type (FIG. 5a) or of the HPS heat pump type (FIG. 5b).

### DETAILED DESCRIPTION

In all figures, elements having the same reference symbols are similar.

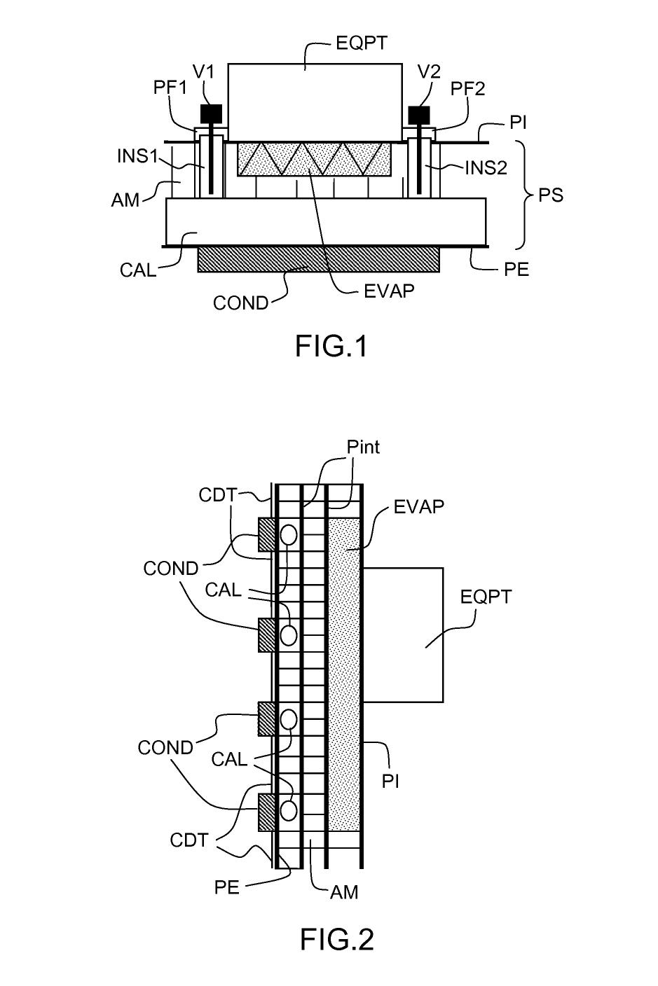

FIG. 1 shows a view in cross-section, along a first axis, of a structural panel PS for a satellite, comprising an outer skin or wall PE intended to be on the outside of the satellite, a core AM, with a honeycomb structure in this example, comprising at least one heat pipe CAL arranged in proximity to the outer skin PE, and an inner skin or wall PI intended to be on the inside of the satellite. Such a structural panel PS can also be referred to as a sandwich-type panel. Equipment EQPT, in this case provided with two fastening lugs PF1 and PF2, is fastened to the structural panel PS by means of two tapped inserts INS1 and INS2 and two screws V1 and V2 screwed respectively into the tapped inserts INS1 and INS2 and the fastening lugs PF1 and PF2. Heat exchangers integrated into the panel PS are shown, in this case an evaporator EVAP arranged within the core AM in proximity to the inner skin PI, and a condenser COND arranged on the outer skin PE on the outside of the panel PS or directly on a heat pipe CAL.

FIG. 2 shows a view in cross-section, along a second axis, orthogonal to the first axis. The core AM can also comprise intermediate walls or skins Pint, for example 0.1 to 0.2 mm thick, and the core can be a honeycomb structure made from aluminum or an insulating material such as glass fiber.

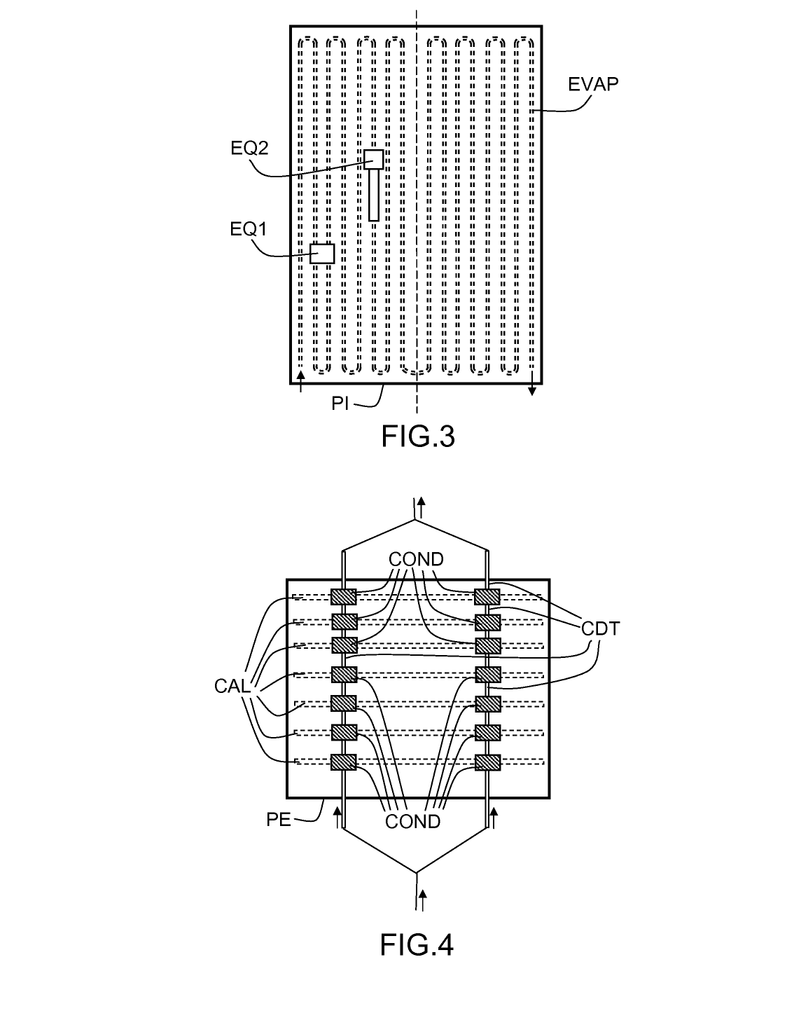

FIG. 3 shows a front view of the inner skin PI of the panel PS, viewed from the outside of the panel PS, corresponding to the inside of the satellite, i.e. from the side of the face of the inner skin PI which is situated on the outside of the panel PS, in which, for example, a coil-type evaporator EVAP with an inlet and an outlet can be seen, which makes it easy to mount several structural panels PS together. The coil-type evaporator EVAP can, for example, draw off heat from a first piece of equipment EQ1 and from a second piece of equipment EQ2, rated at two different temperature levels T1 and T2, for example, T1 being approximately 65° C. and T2 approximately 85° C. As an alternative, other in-series and/or parallel configurations can be envisaged.

FIG. 4 shows a front view of the outer skin PE of the panel PS, viewed from the outside of the panel PS, corresponding to the outside of the satellite, i.e. from the side of the face of the outer skin PE which is situated on the outside of the panel PS, in which a set of condensers COND, for example arranged in two aligned series of condensers COND, can be seen. In each series, the condensers COND are connected by a duct CDT. The panel can comprise any number of series of condensers COND. FIG. 4 shows a structural panel PS which can be associated with a heat control circuit, outside the panel, circulating liquid coolant.

The evaporator exchangers EVAP integrated into these structural panels PS in contact with the inner face of the inner skin PI (i.e. in contact with the inner skin PI of the structural panel PS) can comprise tubes which run in any configuration, in this case (shown in this example) in a coil, with a set spacing. Their arrangement and their dimensions are compatible with the stresses from fastening the equipment EQPT of the payload of the satellite. Heat from the equipment EQPT is transferred to these tubes, inside which the circulating liquid coolant is evaporated. In some operating modes of the heat control systems, only convective, i.e. not two-phase, exchanges can be envisaged. The inside of these tubes, which for example have a circular, rectangular, or square cross-section, can be structured to improve heat exchange, for example by means of grooves or mini-canals. Because this evaporation zone is isothermic (two-phase exchanges) and the tubes are integrated into the panel PS, the stresses from arranging the equipment EQPT of the payload are significantly reduced compared with a conventional heat control system using heat pipes, separated into two temperature zones (for example, an equipment zone rated at 65° C. and an equipment zone rated at 85° C.). This flexible form of arrangement makes it possible to reduce the cabling lengths required for the equipment EQPT of the payload and to have better radio frequency performance for the payload of a satellite in general.

To protect the evaporator exchangers EVAP from the risk of impacts by micrometeorites, thin intermediate skins or walls Pint can be placed in between the inner PI and outer PE skins of the sandwich-type structural panels PS, within the core AM. This type of screen makes it possible to spread the impact of debris striking the panel PS and thus minimize the risk of an evaporator pipe being perforated.

A plurality of such panels PS integrating these evaporator exchangers EVAP can be connected together in any in-series and/or parallel arrangement so as to limit the total head loss in the tubes.

The condenser exchangers COND used are as compact as possible. They are fixed to heat pipes CAL forming a parallel network integrated into these panels PS on the outside (i.e. in contact with the outer skin PE). To minimize thermal gradients from contact, the condenser exchangers COND and heat pipes CAL can also form a single piece. The exchangers can be tubes, generally with a circular, rectangular, or square cross-section, the interior of which can be structured so as to improve heat exchange, for example by means of grooves or mini-canals. The condenser exchangers COND are connected by pipes forming the duct CDT in any in-series and/or parallel configuration, in this case by aligned sets connected in series. Such an arrangement of the condensers COND offers the best thermohydraulic compromise, and the arrangement of the condensers COND on the heat pipes CAL makes it possible to limit the required diameter for the latter and hence limit their length, which limits the production cost (minimizing the mass impact). The use of heat pipes CAL with an 8 to 10 mm diameter, i.e. with a low mass per unit length, is possible. The heat from the exchangers is transferred via the heat pipes CAL to the outer surface PE of the panels PS, serving as a radiator which effectively rejects the heat with the aid of a suitable coating such as a coating with a high infrared emission capacity and a low coefficient of absorption of the solar flux, such as an optical solar reflector (OSR) or a second surface mirror (SSM). The use of a white paint as a radiating coating can also be envisaged.

To protect the condenser exchangers COND from the risk of impact by micrometeorites, the walls need to be hardened, but the hardening entails relatively thin walls because the chosen condenser exchangers are compact (minimized exposed surface area). The walls of the ducts CDT which connect the condenser exchangers COND are hardened too so as to withstand impacts by micrometeorites. Ducts CDT with a small cross-section are thus favored, as long as the thermohydraulic stresses can be respected, in order to limit the effect of this hardening on the mass of the structural panel.

A set of such structural panels PS integrating these condenser exchangers COND can, for example, be connected together in parallel so as to effect optimal and natural thermal coupling in terms of the radiative rejection conditions.

This type of panel with a heat exchanger can have generic dimensions which can be used for the two mechanically pumped control circuits or loops, of the MPL two-phase loop type or of the HPS heat pump type.

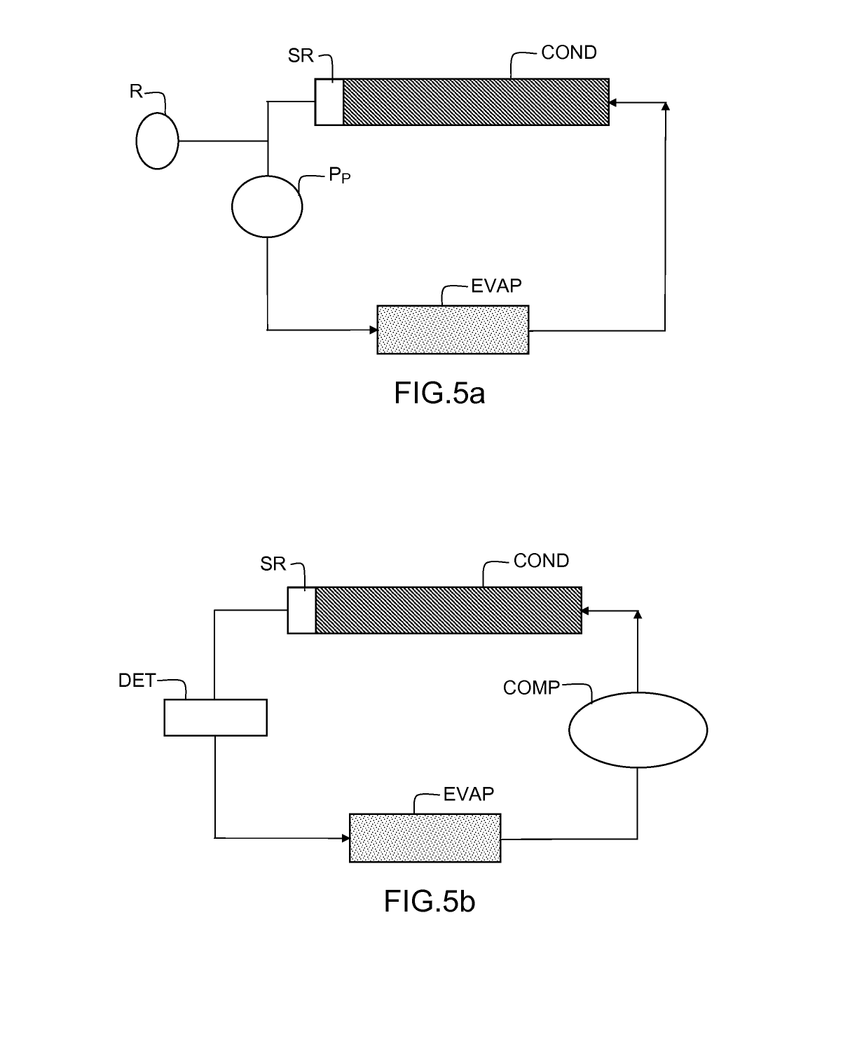

If an MPL circuit is used, as illustrated in FIG. 5a, a pump Pp and a thermohydraulic accumulator or reservoir R are connected to the exchangers upstream of the evaporator exchangers EVAP, viewed in the direction in which the liquid coolant circulates in the loop. Furthermore, a subcooler SR is arranged between the condensers COND and the pump Pp to ensure a sufficient level of subcooling for the fluid at the pump inlet (which prevents cavitation). The core AM of the panels PS can comprise aluminum as the loop functions isothermically, which minimizes heat leakage problems between the inner skin PI and outer skin PE of the panel PS.

If an HPS circuit is used, as illustrated in FIG. 5b, viewed in the direction in which the liquid coolant circulates in the loop, a compressor COMP is arranged downstream of the evaporator exchangers EVAP, and a pressure-reducing valve DET is arranged downstream of the condenser exchangers COND and upstream of the evaporator exchangers EVAP. Furthermore, a subcooler SR can be arranged between the condensers COND and the pressure-reducing valve DET, to increase the efficiency of the refrigeration cycle. The HPS circuit is particularly advantageous when the surface area of the panels PS is not sufficient to evacuate the total dissipation of heat energy emitted by the equipment EQPT of the payload with an MPL circuit (increased rejection capacity as a result of an increased temperature of the radiators). When an HPS circuit is used, the temperature of the outer skins PE of the panels PS of a satellite can be greater than the temperature of the inner skins PI. The core AM of the panels PS is then designed with an insulating effect, and has, for example, a fiberglass design to minimize heat leakage between the two skins or walls PI, PE of a panel PS.

As the ammonia which forms a liquid coolant can be envisaged for both MPL and HPS systems, the design of the heat exchangers integrated into the panel PS can be identical for these two types of heat control.

1. A generic structural panel for a satellite, comprising:
an outer skin intended to be outside the satellite,
a core comprising at least one integrated heat pipe mounted in fixed contact with said outer skin,
an inner skin intended to be inside the satellite, and
generic heat exchangers which are adapted to be associated with a heat control circuit using the circulation of a liquid coolant, said circuit being situated outside the panel.

2. The structural panel as claimed in claim 1, wherein said heat control circuit is a mechanically pumped two-phase heat circuit.

3. The structural panel as claimed in claim 1, wherein said heat exchangers comprise at least one evaporator and one condenser.

4. The structural panel as claimed in claim 3, wherein said condenser is arranged in contact with the outer skin of the panel, facing at least one heat pipe of the core of the panel.

5. The structural panel as claimed in claim 3, wherein said condenser is arranged in contact with at least one heat pipe of the core of the panel.

6. The structural panel as claimed in claim 3, wherein said evaporator is arranged in the core of the panel in contact with the inner skin of the panel.

7. The structural panel as claimed in claim 3, further comprising at least one set of condensers connected in series and/or in parallel by a duct adapted to be part of said heat control circuit, outside the panel.

8. The structural panel as claimed in claim 7, wherein said condensers and the duct connecting them comprise hardened outer walls.

9. The structural panel as claimed in claim 1, wherein the core of the structural panel comprises a thermally insulating or thermally conductive material.

10. The structural panel as claimed in claim 1, configured to be connected hydraulically in series and/or in parallel with one or more other panels.

11. A satellite, comprising at least one structural panel as claimed in claim 1.

12. A satellite, comprising at least one structural panel as claimed in claim 2.

13. A satellite, comprising at least one structural panel as claimed in claim 3.

14. A satellite, comprising at least one structural panel as claimed in claim 4.

15. A satellite, comprising at least one structural panel as claimed in claim 5.

16. A satellite, comprising at least one structural panel as claimed in claim 6.

17. A satellite, comprising at least one structural panel as claimed in claim 7.

18. A satellite, comprising at least one structural panel as claimed in claim 8.

19. A satellite, comprising at least one structural panel as claimed in claim 9.

20. A satellite, comprising at least one structural panel as claimed in claim 10.
